(19) United States
(12) Patent Application Publication
(10) Pub. No.: US 2008/0291392 A1
(43) Pub. Date: Nov. 27, 2008

(54) SYSTEM AND METHOD FOR MARKING AN OPHTHALMIC LENS

(76) Inventors: Joseph E. Sicari, Scottsdale, AZ (US); William E. Meyers, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/102,744

(22) Filed: Apr. 14, 2008

Related U.S. Application Data
(60) Provisional application No. 60/911,430, filed on Apr. 12, 2007.

(51) Int. Cl. G02C 7/04; B29D 11/00

(52) U.S. Cl. 351/160 R; 264/2.7; 264/1.7

(57) ABSTRACT

A system and method for providing a discernable marking within a contact lens including forming a marking section substantially simultaneously with the formation of a bulk section of said lens. The marking section may be formed entirely during formation of the bulk section or may include preformed elements and may be extruded, inlaid, embedded, injected, or dyed within the bulk section. The bulk section may be formed as a rod, a sheet, or as an injection molded lens. The marking section extends substantially from the front to back surfaces of the lens.

### CROSS-REFERENCE TO RELATED APPLICATIONS

This application is a Non-Provisional application of U.S. Provisional Patent Application Ser. No. 60/911,430, entitled “SYSTEM AND METHOD FOR MARKING AN OPHTHALMIC LENS,” which was filed Apr. 12, 2007 and is incorporated herein by reference.

### FIELD OF INVENTION

This invention generally relates to a system and method of marking an ophthalmic lens.

### BACKGROUND OF THE INVENTION

Ophthalmic lenses, commonly referred to as “contact lenses,” typically include a rigid, semi-rigid, or soft lens formed from an opthalmically compatible polymer such as polymethyl methacrylate (PMMA) of hydroxyethyl methacrylate (pHEMA). Lenses are conventionally formed by cutting or centrifugal or injection molding processes. Cut lenses are formed from blanks or sections called “buttons” cut from preformed or, in some cases, an extruded polymer rod stock or stamped from a polymer sheet stock. The buttons are then formed into finished contact lenses, typically through lathe cutting, lapping and other shaping. Alternatively, lenses may be cut directly from the polymer rod stock. Post-formation processes may include hydration, removal of unpolymerized materials, tinting, and sterilization.

Existing lenses may carry an identifying marking such as a letter or symbol to distinguish lenses or lens surfaces, for example, between left and right lenses or between the front and back surfaces of a lens. Similarly, lenses of different prescription may be properly distinguished by a dot or similar marking placed at the periphery of one or both lenses.

Various forms of identifying markings have been proposed including printed, laser radiated, or corona discharge generated markings and surface features having different visual or tactile properties than the lens body. Some proposed identifying markings may not be sufficiently permanent, as with printed dyes that may wear, bleed, or fade during prolonged use.

Other proposed identifying markings may significantly increase the cost of manufacturing due to additional production equipment or increased lens handling required to produce the markings. Furthermore, various proposed identifying markings may further increase the likelihood of contamination, degradation, or discomfort of the lens. For example lens wearers have even reportedly applied their own permanent marker dots to lenses. Additionally, protruding markings or other post formation marking may cause discomfort or present an unnecessary site for build up of deposits.

Accordingly, there exists a need for a system and method for producing, identifying markings that are safe, comfortable, and durable on an ophthalmic lens. Similarly, a need exists for an economic system and method for producing identifying markings on an ophthalmic lens.

### SUMMARY OF THE INVENTION

While the way that the present invention addresses the disadvantages of the prior art will be discussed in greater detail below, in general, the present invention provides a system and method of producing identifying markings in ophthalmic lenses including producing a marking section visually distinct from a bulk section. The marking section extends substantially the thickness of the lens, i.e., substantially from the front surface to the back surface of the lens.

The marking section may be co-extruded, inlaid, embedded, colored or otherwise formed substantially simultaneously with the bulk section of the polymer rod or sheet stock or with the injection of the bulk section. The marking section may thus be formed to substantially the same thickness as the adjacent bulk section in resulting buttons and lenses. Because the marking is integral to and coextensive with the thickness of the bulk section of the lens, the marking is as comfortable and durable as the bulk section of the lens itself.

The visually distinct portion may be of the same or of a different polymer as the bulk section of the polymer stock and may optionally include a colorant, opacity additive, reflective agent or other composition suitable to visually distinguish the marking section.

An exemplary lens according to one embodiment comprises two polymer compositions manufactured to produce a discernable mark at the periphery of the lens. Such manufacturing may be used to form stripes on and/or within both rod stock and sheet stock used to produce the buttons that are then formed into lenses.

In the exemplary context of lenses formed from buttons sectioned from preformed polymer thread or ribbon rod stock, a dyed or semi-opaque polymer is placed in a thin stripe at the periphery of the rod so as to be integral with, yet visually different from, the bulk of the rod. Because the stripe is coextensive in length with the rod, it is coextensive in thickness with any buttons and lenses produced from the rod. This is advantageous over prior marking systems because the marking is as durable and comfortable as the remainder of the lens.

Similarly, the buttons may be stamped from a sheet having a stripe the length of the sheet. The strip is positioned such that the stamped buttons include a small portion of the stripe at the periphery of the button. For example, one stripe running the length of the sheet may be intersected on both sides by rows of buttons.

In various alternative embodiments, the marking section may be preformed and inlayed or embedded within the bulk section of the rod or sheet stock. In other alternative embodiments, the marking section is co-injected with the bulk section in the lens mold.

### BRIEF DESCRIPTION OF THE DRAWINGS

A more complete understanding of the present invention may be derived by referring to the detailed description when considered in connection with the Figures, wherein like reference numerals refer to similar elements throughout the Figures, and

FIG. 1 illustrates an exemplary lens according to one embodiment;

FIG. 2A illustrates an exemplary rod stock having a peripheral marking section according to another embodiment;

FIG. 2B illustrates an exemplary rod stock having an embedded marking section according to another embodiment;

FIG. 3A illustrates an exemplary sheet stock according to another embodiment wherein the peripheral marking section if formed from a coextensive stripe; and

FIG. 3B illustrates an exemplary sheet stock according to another embodiment wherein the peripheral marking section if formed from a coextensive stripe.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternative extrusion, injection, or other production processes and the like and still fall within the scope of the present invention. Thus, the detailed description herein is presented for purposes of illustration only and not of limitation.

In accordance with various aspects of the present invention, a lens is provided with an integral mark for differentiating between lenses. “Lens” as used herein, generally may be construed to mean any ground or molded piece of glass, plastic, or other transparent material with opposite surfaces either or both of which are curved, by means of which light rays are refracted to converge or diverge to form an image. That being said, the present invention is described herein in the exemplary context of an opthalmically compatible contact lens.

The term “button,” as used herein, includes any blank or workpiece from which a lens may be formed. Suitable buttons may be of any shape or size and in general, include a rounded section approximately the size of a lens to be formed therefrom.

The term “section,” as used herein, means any portion, segment, part, or region that forms part of a larger whole. Accordingly, a marking section may be provided within a bulk section and the sections together form part or the whole of a lens. A bulk section is a major portion or the whole of a lens. A marking section is any section that is visually distinct from a larger section of the lens.

The bulk section and/or marking section may be formed by molding or extrusion. For example, one method comprises using a preformed bulk polymer thread or ribbon suspended vertically within a vertical empty tube, closed at the bottom. A marking monomer thread is then introduced into the tube surrounding the thread or ribbon and polymerization is initiated. The rod with thread running through the length of it then sliced into buttons, each button then having the thread or button running through it. When a lens is cut from the button it has the marking thread passing from front to back. In various embodiments, the thread or ribbon may be multilayered to give a pattern to its cross section. Additionally, it may be surface treated to assure good bonding to the newly forming polymer around it and coated to minimize penetration of the monomers into it or the colorant out of it during the rod polymerization.

Alternatively, extrusion is the process of melting and pumping a plastic through a heated die and then cooling the plastic into a specific shape. Coextrusion is the same process, except that multiple extruders pump more than one material into the product. For example, the marking material may be extruded with a bulk section of a rod stock as a peripheral stripe or as a through stripe within a bulk section of a sheet stock. Alternately, the marking section can be formed in a defined area, such as in a stripe or a sequentially alternating material pattern.

Using coextrusion, additional layers can be added to bond the dissimilar layers. These additional layers are known as adhesive or tie layers. However, in some instances, some materials are difficult to coextrude, for example, due to significantly different melting points and viscosity curves. Nonetheless, when it is possible to coextrude, even different materials, the same may fall within the scope of the present invention.

For lenses made from polymer sheeting, the marking section may be colored, inlaid, embedded or otherwise formed during extrusion of the bulk section of the polymer sheet. For other manufacturing methods, such as injection molded lenses and/or those through various processes described herein, the marking section may be colored, inlaid, embedded or otherwise formed substantially simultaneously with injection of the bulk section polymer composition.

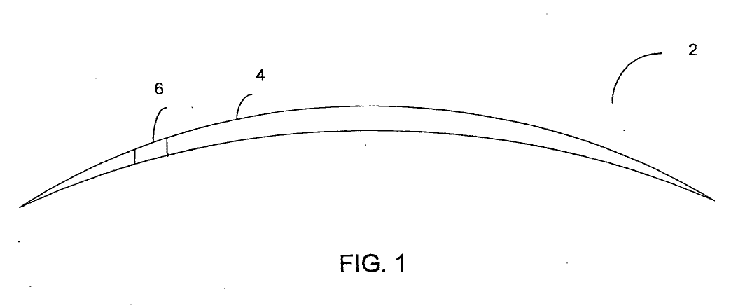

With reference now to FIG. 1, an exemplary lens 2, according to one embodiment of the present invention, includes a bulk section 4 and a marking section 6 that is visually distinct from bulk section 4 at a distance. Marking section 6 extends substantially from the front convex surface of lens 2 to the rear concave surface of lens 2. Stated otherwise, marking section 6 is substantially coextensive in thickness with an adjacent portion of bulk section 4.

In various alternative embodiments, marking section 6 may be at least partially covered by bulk section 4 at either or both of the front or rear surfaces of lens 2. For example, marking section 6 may comprise a preformed plug embedded in bulk section 4. In the event that the preformed plug is thinner than the finished thickness of lens 2, bulk section 4 may fill the thickness gap during formation of lens 2.

Marking section 6 may be of the same or different base composition as bulk section 4. Additionally, marking section 6 may include any dye, colorant, opacity gradient, reflective agent, or other filler or additive suitable to visually distinguish marking section 6 from bulk section 4. Bulk section 4 and/or marking section 6 may be formed from any material having suitable opthalmic compatibility. Exemplary opthalmically compatible materials include silicone, silicone hydrogel, silicone-acrylate and fluoro-silicone-acrylate materials. Exemplary gas penneable materials include Kolfocon A-C (Dk 18-54), Sterafocon A (Dk 30), PERM 15 (Dk 15), Pemufocon A (Dk 25), FSA-30 (Dk 30), FSA-60 (Dk 60), FSA-90 (Dk 90), FSA-151 (Dk 151), Oxyflufocon A (Dk 60), PERM F40 (Dk 40), HS-40 (Dk 40), HS-56 (Dk 56), Filofocon A (Dk 40), Onsifocon A (Dk 56), Wilofocon A (Dk 27), and Hofocon A (Dk 97). The general principles of oxygen transport through silicone-containing polymers are generally known in the art, and therefore, are not addressed here.

Any such materials may be readily altered by varying the ratios of silicone monomer or other material components. Any number of material additives may also be used in accordance with the present invention. For example, fillers, tints, dyes, reinforcing microfibers, impact modifiers, antioxidants, heat stabilizers, ultraviolet stabilizers, ultraviolet blockers, and colorant compositions may be used to provide desired mechanical properties or performance characteristics.

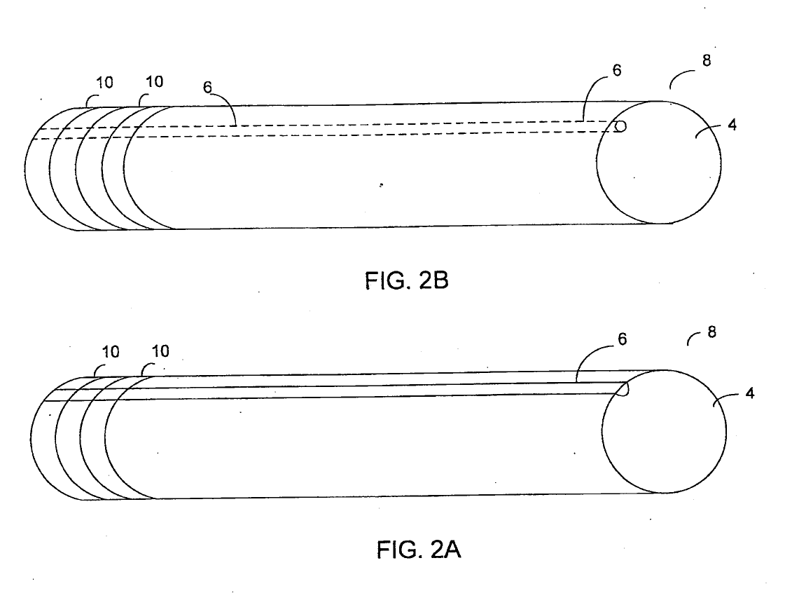

With reference now to FIG. 2a, an exemplary rod stock 8 is shown according to another embodiment of the present invention in which buttons 10 are sectioned from rod stock 8 for use in forming lenses 2. Rod stock 8 and corresponding buttons 10 comprise a bulk section 4 and a marking section 6. In some embodiments, bulk section 4 and marking section 6 may be coextruded to form rod stock 8. Alternatively, marking section 6 may be preformed and embedded within bulk section 4 during formation of bulk section 4. As shown in FIG. 2a, marking section 6 may be disposed at the periphery of rod stock 8 and buttons 10. Alternatively, as shown in FIG. 2b, marking section 6 may be disposed radially inward of the peripheral edge of rod stock 8 and buttons 10.

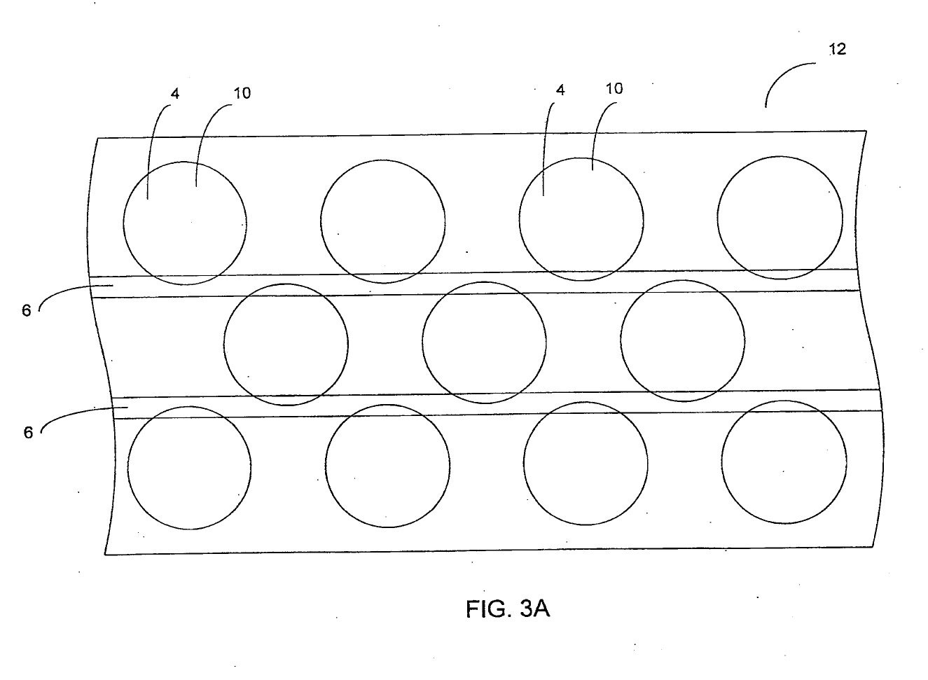

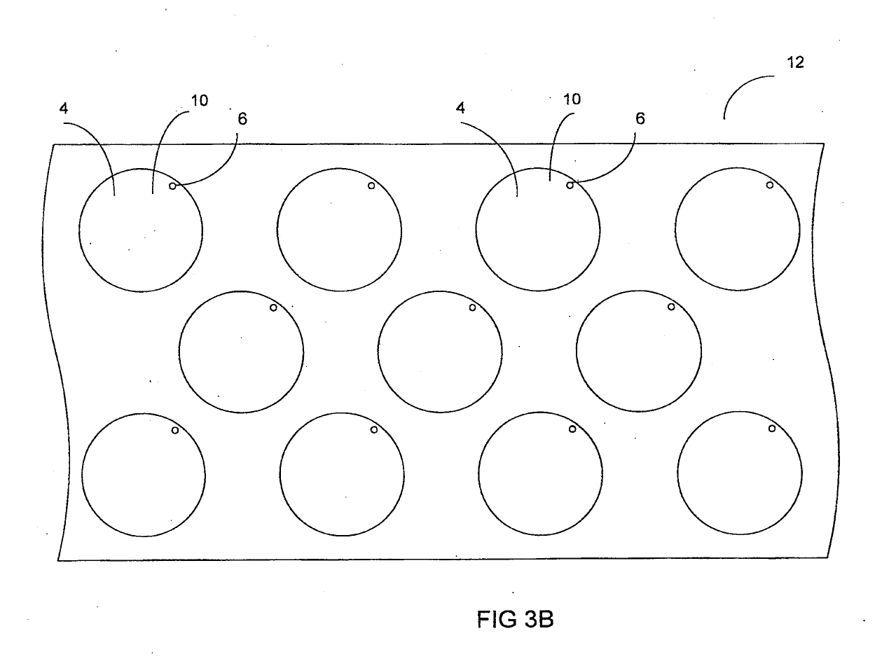

With reference now to FIG. 3a, another exemplary extruded sheet stock 12 is shown according to another embodiment of the present invention in which buttons 10 are sectioned from sheet stock 12 for use in forming lenses 2. Sheet stock 12 includes a bulk section 4 and a marking section 6. Marking section 6 may be co-manufactured with bulk section 4 and may be positioned, shaped, or otherwise configured to comprise any desired portion of sheet stock 12 to produce the desired marking section configuration within buttons 10 sectioned from sheet stock 12. For example, marking section 6 may comprise a stripe formed within sheet stock 12 such that the stripe intersects the peripheries of adjacent rows of buttons 10 to be sectioned from sheet stock 12. Thus, more than one marking section 6 may be present in a given button 10. In various alternative embodiments, marking section 6 within sheet stock 12 may be a preformed ribbon, may be continuous, intermittent, undulating, asymmetrical, or of any other configuration suitable to produce a visually distinct portion of buttons 10.

It is contemplated that marking section 6 may alternatively be made visually distinct from bulk section 4 during any post extrusion process, such as, for example, lens dying, plasma coating, and the like. Thus, any process by which marking section 6 is made visually distinguishable from a substantially coextensive thickness of adjacent bulk section 4 is contemplated by the present invention.

With reference now to FIG. 3b, an exemplary sheet stock 12 is shown according to another embodiment of the present invention in which marking sections 6 are configured as discrete sections located within buttons 10. For example, marking sections 6 may be co-extruded, injected, embedded, inlaid, encased, encapsulated.

Marking section 6 may be comprise one color or other indicia or visual characteristic to indicate a left lens and another to indicate a right lens. It may be advantageous to position marking section 6 substantially outside the center of field of view of the wearer. Similarly, it may be advantageous for marking section 6 to be substantially transparent or otherwise small enough so as not to impede the vision of the wearer.

In accordance with an exemplary method of marking an ophthalmic lens, bulk section 4 is formed into rod stock 8 or sheet stock 12, for example, through extrusion. Marking section 6 is formed or placed therein substantially simultaneous to formation of rod stock 8 or sheet stock 12 to facilitate adequate integrity of the combination of marking section 6 and bulk section 4. Marking section 6 may be coextruded with bulk section 4 or may be preformed, for example, as a plug or ribbon, and subsequently embedded or inlaid or otherwise integrated during formation of sheet stock 12 or rod stock 8. For example, marking section 6 may comprise a molded plug or a plug sectioned from a ribbon.

In an alternative method of marking an ophthalmic lens, a first polymeric composition is injected into a lens mold and a marking section of a second composition is introduced, substantially simultaneous to the injecting of the first composition. The second composition may also be injected into the lens mold or may be a solid introduced into the mold at some point prior to curing of the first composition within the mold. Thus, a plug may be placed in the mold prior to injection such that it forms marking section 6 of lens 2 during injection of the composition comprising bulk section 4. Alternatively, the plug may be introduced into the mold during or after injection of the first composition, prior to curing of the first composition.

Marking section 6 is configured to be visually distinct from bulk section 4 of a finished lens 2. This distinction may be accomplished by addition of any combination of dyes, colorants, opacity or reflective gradients and the like to marking section 6 and/or bulk section 4. It may be advantageous to produce marking section 6 to be substantially coextensive in thickness with the adjacent portion of bulk section 4. It may be further advantageous to select the composition of bulk section 4 and marking section 6 to permit or maximize crosslinking or other bonding therebetween.

Similarly, while the present invention has been described herein a system and method for marking an ophthalmic lens, the present invention may be readily used with any number of optic lenses or other similar devices now known or hereafter developed.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. An opthalmic lens having a marking formed therein wherein said lens comprises:
a bulk section; and
a marking section visually distinct from said bulk section, said marking section extending substantially from a front surface of said lens to a rear surface of said lens.

2. The lens of claim 1, wherein said bulk section comprises a first polymer composition and said marking section is produced by at least one of extruding, inlaying, and embedding a second polymer composition within said bulk section.

3. The lens of claim 1, wherein said marking section comprises at least one of a colorant, opacity gradient, and a reflective agent.

4. The lens of claim 3, wherein said marking section is formed from a polymer having substantially the same base composition as said bulk portion.

5. The lens of claim 1, where said marking section comprises a preformed ribbon encapsulated by said bulk section during extrusion of said bulk section.

6. The lens of claim 1, wherein said marking section is substantially co-extensive with the thickness of an adjacent portion of said bulk section.

7. The lens of claim 1, wherein said marking section of a first lens exhibits a first visual characteristic indicative of one of a left eye lens or a right eye lens.

8. The lens of claim 7, wherein said marking section of a second lens exhibits a second visual characteristic different from said first visual characteristic to indicate the other one of said left eye lens and said right eye lens.

9. The lens of claim 1, wherein said marking section comprises a visual characteristic distinguishable from said bulk section when not placed on an eye and not distinguishable to the wearer when placed on an eye.

10. A method of forming polymeric stock for use in producing an opthalmic lens having a discernable marking formed therein, the method comprising the steps of:
extruding a bulk section of a polymeric stock, said polymeric stock comprising one of a rod and a sheet; and
producing a marking section within said polymeric stock visually distinct from said bulk section and extending substantially the finished thickness of said lens.

11. The method of claim 10, wherein said marking section is produced by at least one of extruding, inlaying, and embedding of said marking section within said bulk section.

12. The method of claim 11, wherein said marking section is formed from a polymer having substantially the same base composition as said bulk portion.

13. The method of claim 10, where said marking section comprises one of a preformed ribbon and a preformed plug introduced into said polymeric stock during extrusion of said bulk section.

14. The method of claim 10, wherein said marking section comprises at least one of a colorant, an opacity gradient, and a reflective agent.

15. The method of claim 10, wherein said marking section is substantially co-extensive with an adjacent portion of said bulk section prior to formation of said lens.

16. The method of claim 10, wherein said marking section of a first lens exhibits a first visual characteristic indicative of one of a left eye lens and a right eye lens.

17. The method of claim 16, wherein said marking section of a second lens exhibits a second visual characteristic different from said first visual characteristic to indicate the other one of said left eye lens and said right eye lens.

18. The method of claim 10, wherein said marking section is formed in advance of said bulk section and is crosslinked thereto during extrusion of said bulk section.

19. The method of claim 10, wherein said marking section is located at the periphery of said lens.

20. A method of forming a discernable mark within a contact lens, said method comprising:
injecting a first polymer composition into a lens mold; and
forming a marking section within said lens, said second polymer composition exhibiting different visual characteristics from said first polymer composition in said lens.

21. The method of claim 20, wherein said marking section extends substantially the thickness of said lens.

22. The method of claim 21, wherein said second polymer composition comprises at least one of a colorant, an opacity gradient, and a reflective agent.

23. The method of claim 21, wherein forming said marking section comprising injecting a second polymer composition into said lens mold.

24. The method of claim 21, wherein forming said marking section comprises disposing a preformed section within said mold.

25. The method of claim 21, wherein said preformed section is positioned is said mold prior to said injecting.
